(19) United States
(12) Patent Application Publication
(10) Pub. No.: US 2022/0082790 A1
(43) Pub. Date: Mar. 17, 2022

(54) CONCAVE MIRROR

(71) Applicant: MINEBEA MITSUMI Inc., Nagano (JP)

(72) Inventors: Masatoshi MIYASHITA, Fukuroi-shi, Shizuoka (JP); Takuya NAGAI, Fukuroi-shi, Shizuoka (JP)

(21) Appl. No.: 17/262,388

(22) PCT Filed: Mar. 12, 2020
(86) PCT No.: PCT/JP2020/010738

§ 371 Date: Jan. 22, 2021

(30) Foreign Application Priority Data
May 31, 2019 (JP) 2019-102885

(51) Int. Cl. G02B 7/182; B60K 35/00; G02B 27/01; G02B 5/10

(52) U.S. Cl. CPC G02B 7/182; B60K 35/00; G02B 27/0101; B60K 2370/816; B60K 2370/1529; B60K 2370/23; G02B 5/10

(57) ABSTRACT

To mount a concave mirror to a structure with a simple configuration. The concave mirror includes a concave mirror body made of glass, at least one bracket formed of material with light-impermeable properties, and an adhesive having ultraviolet-curing properties to bond the bracket to an underside reflective surface of the concave mirror body, wherein the bracket includes a bonded surface portion to be bonded to an underside reflective surface through the adhesive, the underside reflective surface being a surface of the concave mirror body opposite to a reflective surface thereof, and a plurality of through holes, each of the through holes having one end facing the bonded surface portion and another end facing an outside surface that is a surface opposite to the bonded surface portion, each of the through holes passing through between the bonded surface portion and the outside surface.

### TECHNICAL FIELD

The present invention relates to a concave mirror.

### BACKGROUND ART

A head-up display device is commonly known as a device that displays a virtual image on a windshield of a moving body such as a vehicle or an aircraft.

The head-up display device is mounted, for example, inside an instrument panel of a vehicle. The head-up display device mainly includes a light source, a display, and a mirror unit including a concave mirror. The concave mirror projects a virtual image of display light, emitted by the display upon receiving light from the light source, on the windshield (see Patent Literature 1).

Document List

### PATENT LITERATURE

Patent Literature 1: Japanese Patent Application Publication No. 2016-38515

### SUMMARY OF INVENTION

### Technical Problem

Since it is desired to increase the display area of a head-up display device, there is a need for increasing the area of the reflective surface of a concave mirror that projects a virtual image. It is desired to use a concave mirror made of glass to ensure its durability and rigidity simultaneously with increasing the area of the reflective surface, and to improve the accuracy of displaying a virtual image.

However, in contrast to a concave mirror made of resin, it is difficult for a concave mirror made of glass that a bracket, to be used for mounting this concave mirror to a structure of a head-up display device, a vehicle, or the like, is formed integrally with the concave mirror body. The concave mirror made of glass has a smooth surface on both the reflective surface and the underside that is a surface opposite to this reflective surface. It is thus necessary for the conventional concave mirror made of glass that the bracket is formed into a frame shape to surround the outer periphery of the concave mirror body. This makes the component configuration more complicated. In addition, the conventional concave mirror made of glass is prevented by the frame shape of the bracket from increasing the effective area of the reflective surface.

The present invention has been made in view of the above problems as an example, and it is an object of the present invention to provide a concave mirror that can be mounted to a structure with a simple configuration.

### Solution to Problem

To achieve the above object, a concave mirror of the present invention includes: a concave mirror body made of glass; at least one bracket formed of material with light-impermeable properties; and an adhesive having ultraviolet-curing properties to bond the bracket to an underside reflective surface of the concave mirror body, wherein the bracket includes a bonded surface portion to be bonded to an underside reflective surface through the adhesive, the underside reflective surface being a surface of the concave mirror body opposite to a reflective surface thereof, and a plurality of through holes, each of the through holes having one end facing the bonded surface portion and another end facing an outside surface, the outside surface being a surface opposite to the bonded surface portion, each of the through holes passing through between the bonded surface portion and the outside surface.

In the concave mirror according to one aspect of the present invention, the bracket is bonded to the underside reflective surface on an inner side relative to an outer-peripheral end portion of the concave mirror body.

In the concave mirror according to one aspect of the present invention, the bracket includes an enlarged portion around an outer circumference of the through hole at the one end, the enlarged portion being enlarged more than the through hole.

In the concave mirror according to one aspect of the present invention, the through holes are arrayed in a lattice pattern.

In the concave mirror according to one aspect of the present invention, the bonded surface portion has a shape corresponding to a planar shape of the underside reflective surface.

The concave mirror according to one aspect of the present invention includes a primer provided between the adhesive and the bonded surface portion.

In the concave mirror according to one aspect of the present invention, ultraviolet light irradiated from at least either an underside reflective surface side or another end side of the through hole is reflected off an underside of a reflective coating formed on the concave mirror body, and then reaches between the bonded surface portion and the underside reflective surface, and thereby the adhesive is cured.

A concave mirror of the present invention can be mounted to a structure with a simple configuration.

### BRIEF DESCRIPTION OF DRAWINGS

FIG. 1 A perspective view schematically illustrating the configuration of a concave mirror according to an embodiment of the present invention.

FIG. 2 A cross-sectional view schematically illustrating the configuration of the concave mirror illustrated in FIG. 1.

FIG. 3 A cross-sectional view schematically illustrating the configuration of the concave mirror illustrated in FIG. 1.

FIG. 4 A perspective view of a concave mirror body illustrated in FIG. 1.

FIG. 5 A perspective view of the concave mirror body illustrated in FIG. 4.

FIG. 6 A rear view of a bracket illustrated in FIG. 1.

FIG. 7 A front view of the bracket illustrated in FIG. 6.

FIG. 8 A cross-sectional view of the concave mirror illustrated in FIG. 1, and schematically illustrating a step of curing an adhesive.

### DESCRIPTION OF EMBODIMENTS

Hereinafter, a concave mirror 1 according to an embodiment of the present invention will be described with reference to the drawings.

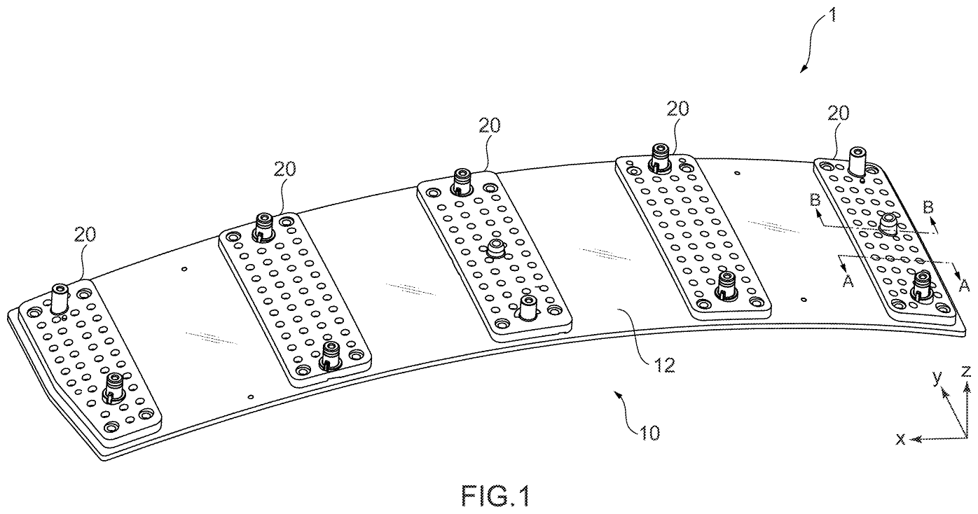

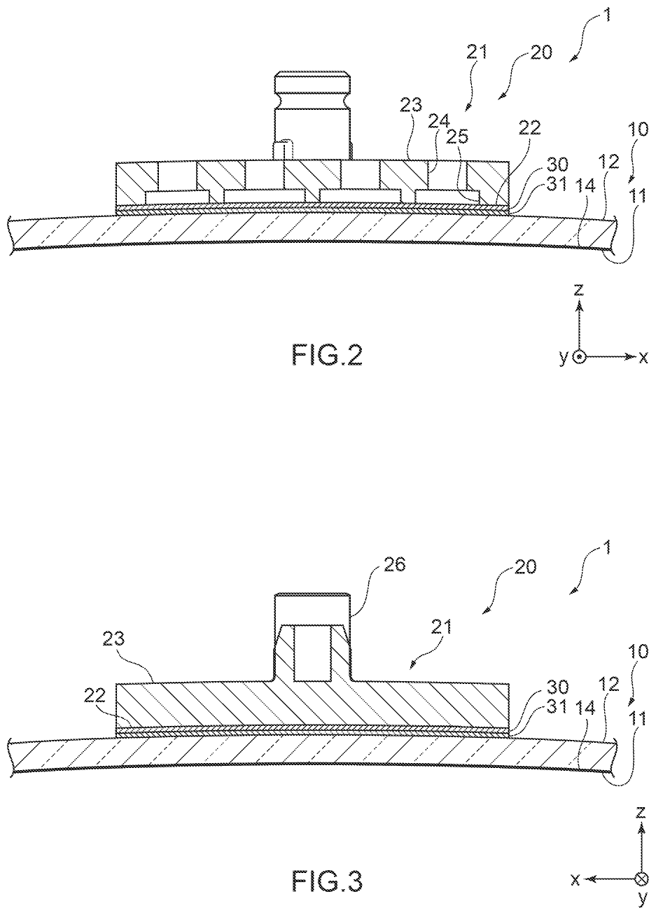

FIG. 1 is a perspective view schematically illustrating the configuration of the concave mirror 1 according to the embodiment of the present invention. FIGS. 2 and 3 are cross-sectional views schematically illustrating the configuration of the concave mirror 1.

In the descriptions below, a longitudinal direction (horizontal direction or width direction) of a concave mirror body 10 of the concave mirror 1 in FIG. 1 is defined as an x-axis direction, a shorter-side direction (vertical direction or height direction) of the concave mirror body 10 perpendicular to the x-axis is defined as a y-axis direction, and a direction (depth direction) running through the concave mirror body 10 and perpendicular to each of the x-axis and the y-axis is defined as a z-axis direction. In the descriptions below, one side of the concave mirror 1 facing a reflective surface 11 is defined as a front side, while another side of the concave mirror 1 facing an underside reflective surface 12 illustrated in FIG. 1 is defined as a back side.

As illustrated in FIGS. 1 to 3, the concave mirror 1 according to the present embodiment includes the concave mirror body 10 made of glass, at least one bracket 20 formed of material with light-impermeable properties, and an adhesive 30 having ultraviolet-curing properties to bond the bracket 20 to the underside reflective surface of the concave mirror body 10. The bracket 20 includes a bonded surface portion 22 to be bonded to the underside reflective surface 12 through the adhesive 30, the underside reflective surface 12 being a surface of the concave mirror body 10 opposite to the reflective surface 11 thereof, and a plurality of through holes 24, each of which has one end facing the bonded surface portion 22 and another end facing an outside surface 23 that is a surface opposite to the bonded surface portion 22, each of the through holes 24 passing through between the bonded surface portion 22 and the outside surface 23. Hereinafter, the configuration of the concave mirror 1 is specifically described.

Configuration of Concave Mirror Body

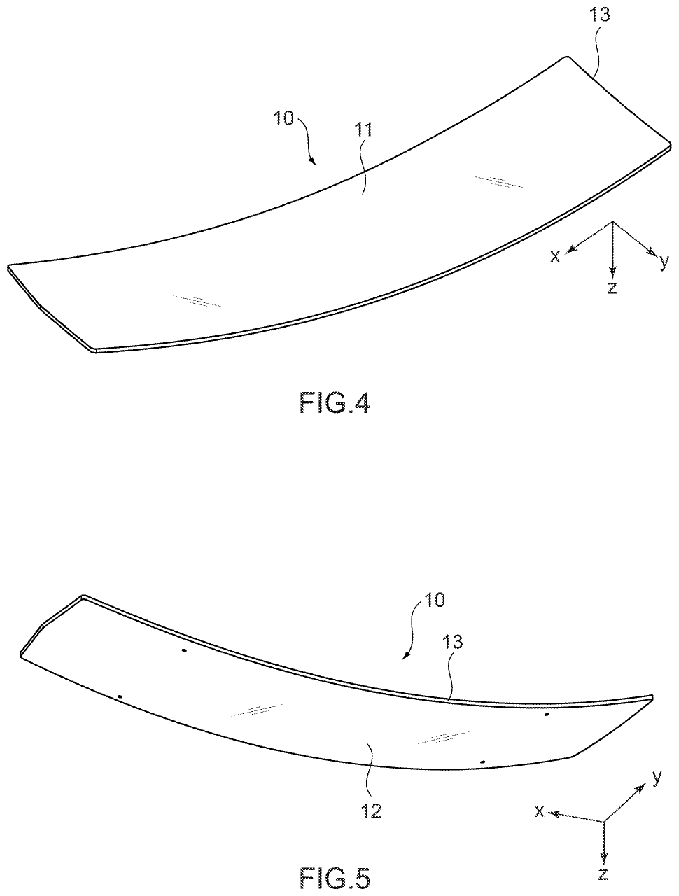

FIGS. 4 and 5 are perspective views of the concave mirror body 10. FIG. 4 illustrates the concave mirror body 10 when viewed in a direction toward the reflective surface 11 formed into a concave shape. FIG. 5 illustrates the concave mirror body 10 when viewed in a direction toward the underside reflective surface 12 that is a surface opposite to the reflective surface 11. As illustrated in FIGS. 4 and 5, the concave mirror body 10 includes the reflective surface 11 that is a mirror surface formed into a curved concave shape, the underside reflective surface 12 that is a surface opposite to the reflective surface 11, and an outer-peripheral end portion 13 formed at an edge portion along the outer periphery of the reflective surface 11 and the underside reflective surface 12. The concave mirror body 10 is made of glass, and obtains a function of reflecting light from a reflective coating 14 of metal such as aluminum evaporated on the reflective surface 11. The concave mirror body 10 is not limited to a particular shape, dimension, curvature, or the like as long as the reflective surface 11 is formed into a concave shape.

Configuration of Bracket

At least one or more brackets 20 (for example, five brackets 20 as illustrated in FIG. 1) are provided on the underside reflective surface 12 of the concave mirror body 10 of the concave mirror 1. As illustrated in FIG. 1, the brackets 20 are bonded to the underside reflective surface 12 of the concave mirror body 10 on the inner side (more toward the central portion) relative to the outer-peripheral end portion 13 of the concave mirror body 10. That is, the brackets 20 do not protrude outward from the outer-peripheral end portion 13 of the concave mirror body 10 in either the x-axis direction or the y-axis direction.

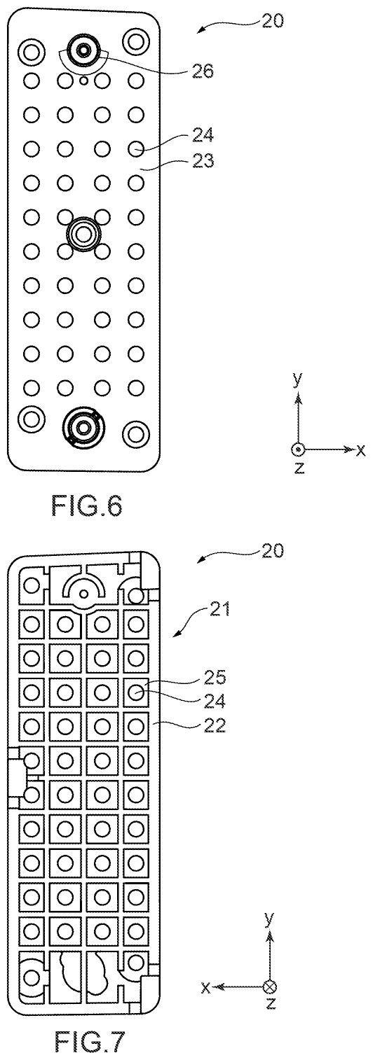

FIG. 6 is a rear view of the bracket 20. FIG. 7 is a front view of the bracket 20. As illustrated in FIGS. 6 and 7, the bracket 20 includes a bracket body 21, the bonded surface portion 22, the outside surface 23, the through holes 24, enlarged portions 25, and boss portions 26.

The bracket body 21 defines the entire shape of the bracket 20. The bracket body 21 is formed of material with light-impermeable properties, for example, resin material. The bracket 20 is formed into an approximately square shape in front view with a greater length in the shorter-side direction (y-axis direction) of the concave mirror body 10 than the length in the longitudinal direction (x-axis direction) thereof.

The bonded surface portion 22 is provided on the front side of the bracket body 21, and has a predetermined area in the x-axis direction and the y-axis direction. The bonded surface portion 22 has a shape corresponding to the planar shape of the underside reflective surface 12 of the concave mirror body 10. For example, when the concave mirror body 10 has a three-dimensional curved surface with a predetermined curvature, the bonded surface portion 22 has a three-dimensionally curved-surface shape with a curvature corresponding to this predetermined curvature. The bonded surface portion 22 is bonded accurately to the underside reflective surface 12 that is a surface (back side) of the concave mirror body 10 opposite to the reflective surface 11. Note that the bonded surface portion 22 may have any shape as long as the bonded surface portion 22 can be bonded to the underside reflective surface 12.

The outside surface 23 is provided on the back side of the bracket body 21, and has a predetermined area in the x-axis direction and the y-axis direction similarly to the bonded surface portion 22. For example, the outside surface 23 may have a shape corresponding to the planar shape of the underside reflective surface 12 of the concave mirror body 10 similarly to the bonded surface portion 22. However, the shape of the outside surface 23 is not limited thereto.

As illustrated in FIG. 2, the through holes 24 are holes which extend in the z-axis direction (thickness direction) of the bracket body 21. Each of the through holes 24 has one end in the z-axis direction facing the bonded surface portion 22 on the front side, and another end in the z-axis direction facing the outside surface 23 on the back side, and passes through between the bonded surface portion 22 and the outside surface 23. As illustrated in FIGS. 6 and 7, a plurality of the through holes 24 are provided in the bracket body 21, and are arrayed, for example, in a lattice pattern at equal intervals or approximately equal intervals in the x-axis direction and the y-axis direction. Each of the through holes 24 has, for example, a round hole shape in front view.

As illustrated in FIG. 2, the enlarged portions 25 are provided on one end side of the through holes 24, that is, around the outer circumference of the end portion of the through holes 24 on the bonded surface portion 22. Each of the enlarged portions 25 has a larger diameter than the through hole 24. As illustrated in FIG. 7, the enlarged portion 25 is formed into, for example, a square hole shape in front view. A plurality of the enlarged portions 25 are provided along with the through holes 24 in the bracket body 21, and are arrayed, for example, in a lattice pattern at equal intervals or approximately equal intervals in the x-axis direction and the y-axis direction. The through holes 24 and the enlarged portions 25 are provided, and thus the bonded surface portion 22 of the bracket body 21 is formed into a grid shape between a plurality of the enlarged portions 25 and in the outer peripheral edge.

The boss portions 26 are provided on the outside surface 23 of the bracket body 21. Each of the boss portions 26 engages with a counterpart boss portion (not illustrated) mounted to an object to which the concave mirror 1 is fixed through the bracket 20 (for example, the object is a housing of a head-up display device (not illustrated), or a structure of a moving body (not illustrated) such as a vehicle equipped with the head-up display device). The shape, position, and other factors of the boss portions 26 are not limited to the example illustrated in FIGS. 1 and 6.

As illustrated in FIGS. 2 and 3, the adhesive 30 is provided between the bonded surface portion 22 of the bracket body 21 and the underside reflective surface 12 of the concave mirror body 10. The adhesive 30 is a low-stress adhesive with ultraviolet-curing properties to be used to bond the bracket 20 to the underside reflective surface 12 of the concave mirror body 10. A primer 31 may be provided between the adhesive 30 and the underside reflective surface 12. The primer 31 improves adhesiveness to glass and has a stress relaxation function. It is desirable that the adhesive 30 and the primer 31 are applied evenly between the bonded surface portion 22 and the underside reflective surface 12.

Function of Concave Mirror

Next, the function of the concave mirror 1 including the configurations explained above is described. In the concave mirror 1, in the manner as described above, the brackets 20 are bonded to the underside reflective surface 12 of the concave mirror body 10 by using the adhesive 30 with ultraviolet-curing properties. When bonded to the underside reflective surface 12, each of the brackets 20 is positioned such that the bonded surface portion 22 is opposed to the underside reflective surface 12. The bonded surface portion 22 is applied with the adhesive 30 and the primer 31 in advance. The concave mirror body 10 is joined to the brackets 20 in such a manner that the underside reflective surface 12 faces toward the bonded surface portion 22 of the brackets 20. After the concave mirror body 10 and the brackets 20 are joined, the above jig is used to prevent misalignment between the concave mirror body 10 and the brackets 20, and then a step of curing the adhesive 30 is performed by using ultraviolet light.

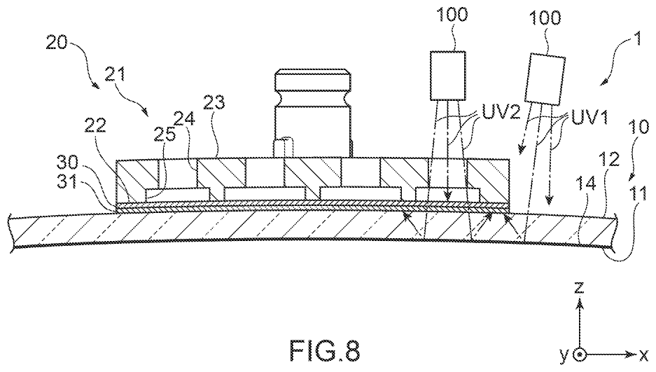

FIG. 8 is a cross-sectional view of the concave mirror 1, and schematically illustrates a step of curing the adhesive 30. As illustrated in FIG. 8, a UV irradiator 100 irradiates the underside reflective surface 12 of the concave mirror body 10 with ultraviolet light from the outside of the underside reflective surface 12. A plurality of the brackets 20 are located separately on the underside reflective surface 12 of the concave mirror body 10. This makes it possible for ultraviolet light UV1 irradiated from the UV irradiator 100 to pass through a region of the underside reflective surface 12, where the brackets 20 are not located. The ultraviolet light UV1 irradiated from the UV irradiator 100 is directly incident to the underside reflective surface 12. The ultraviolet light UV1 incident to the underside reflective surface 12 is reflected off the underside of the reflective coating 14, such as a high-reflection aluminum coating, formed on the concave mirror body 10. The ultraviolet light UV1 reflected off the underside of the reflective coating 14 reaches the adhesive 30 provided between the underside reflective surface 12 and the bonded surface portion 22. The adhesive 30 is irradiated with the ultraviolet light UV1 and then cured.

That is, in the concave mirror 1, a plurality of the brackets 20 are located separately, so that the adhesive 30 can be cured by the ultraviolet light UV1 irradiated to the region of the underside reflective surface 12 where the brackets 20 are not located.

In addition, ultraviolet light UV2 irradiated from the UV irradiator 100 is incident to the adhesive 30 present between the underside reflective surface 12 and the bonded surface portion 22 from the through holes 24 formed on the outside surface 23 of the bracket body 21. The ultraviolet light UV2 having passed through the adhesive 30 is incident to the underside reflective surface 12. The ultraviolet light UV2 incident to the underside reflective surface 12 is reflected off the underside of the reflective coating 14 in the same manner as the ultraviolet light UV1. The ultraviolet light UV2 reflected off the underside of the reflective coating 14 reaches the adhesive 30 present between the underside reflective surface 12 and the bonded surface portion 22. The adhesive 30 is irradiated with the ultraviolet light UV2 and then cured. As described above, each of the brackets 20 is provided with the through holes 24 through which the adhesive 30 is irradiated with the ultraviolet light UV2 having passed through a different path from that of the ultraviolet light UV1.

The ultraviolet light UV2 reflected off the underside of the reflective coating 14 reaches the adhesive 30 present between the underside reflective surface 12 and the bonded surface portion 22 via a plurality of paths. The adhesive 30 is irradiated with the ultraviolet light UV2 and is thereby cured. The adhesive 30 is cured, so that the brackets 20 are fixed to the concave mirror body 10 in the concave mirror 1.

In the manner as described above, the concave mirror 1 can improve the efficiency of usage of the ultraviolet light UV2 used to cure the adhesive 30. Therefore, in the concave mirror 1, each of the brackets 20 is provided with the through holes 24, and consequently this can reduce the time required to cure the adhesive 30, and can accordingly improve workability during production of the concave mirror 1.

The concave mirror 1 configured in the manner as described above uses the adhesive 30 with ultraviolet-curing properties to mount the brackets 20 on the inner side of the concave mirror body 10 made of glass. It is thus unnecessary for the concave mirror 1 to form the bracket 20 into a frame shape to surround the outer periphery of the concave mirror body 10. The brackets 20 are mounted on the inner side of the concave mirror body 10 by using the adhesive 30, so that it is possible to use the concave mirror 1, including the end portion of the concave mirror body 10 along the outer periphery, as a reflective surface. Accordingly, the concave mirror 1 can maximize the area that can be used as a reflective surface.

The brackets 20 are formed of material with light-impermeable properties. Each of the brackets 20 is provided with a plurality of the through holes 24 passing through between the bonded surface portion 22 and the outside surface 23. As described above, in the step of curing the adhesive 30, the through holes 24 allow the ultraviolet light UV2 from the UV irradiator 100 to pass through and spread throughout the bonded surface portion 22 applied with the adhesive 30. The through holes 24 are provided, so that the adhesive 30 can not only spread in a planar direction (in the x-axis direction and y-axis direction), but can also spread three-dimensionally (in the z-axis direction) between the bonded surface portion 22 and the underside reflective surface 12. Thus, in the concave mirror 1, the brackets 20 are firmly fixed to the underside reflective surface 12 of the concave mirror body 10 made of glass. Further, the through holes 24 are provided, so that air bubbles generated inside the adhesive 30 can be discharged to the outside through the through holes 24.

### Effects of Embodiment

As described above, the concave mirror 1 uses the adhesive 30 with ultraviolet-curing properties and a low curing stress to mount the brackets 20 to the concave mirror body 10. Thus, the concave mirror body 10 made of glass is prevented from being cracked, and the entire region of the reflective surface 11 in the concave mirror body 10 can be used as a reflective surface. In the concave mirror 1, the brackets 20 are separately located and include the through holes 24. This makes it possible to irradiate the adhesive 30 with the ultraviolet light UV1 and UV2 having passed through a plurality of paths. Further, in the concave mirror 1, the ultraviolet light UV2 having passed through the adhesive 30 via the through holes 24 is reflected off the reflective surface 11 and is again incident to the adhesive 30. This can reduce the time required to cure the adhesive 30, and improves productivity accordingly.

In the bracket 20, the through holes 24 are arrayed in a lattice pattern. The bonded surface portion 22 of the bracket 20 has a shape corresponding to the planar shape of the underside reflective surface 12. Further, the concave mirror 1 includes the primer 31 provided between the adhesive 30 and the bonded surface portion 22. As described above, in the concave mirror 1, the brackets 20 are more firmly fixed to the underside reflective surface 12 of the concave mirror body 10 made of glass.

The brackets 20 are bonded to the underside reflective surface 12 of the concave mirror body 10 on the inner side relative to the outer-peripheral end portion 13. This can downsize the entire configuration of the concave mirror 1.

Each of the brackets 20 includes the enlarged portion 25 around the outer circumference of the through hole 24. This allows the adhesive 30 to further spread three-dimensionally (in the z-axis direction). Thus, in the concave mirror 1, the brackets 20 are firmly fixed to the underside reflective surface 12 of the concave mirror body 10 made of glass.

Therefore, the concave mirror 1 can be mounted to a structure with a simple configuration.

Those skilled in the art can appropriately modify the concave mirror of the present invention in accordance with conventionally known knowledge. It is apparent that such modifications are also included in the scope of the present invention as long as the modifications include the configurations of the present invention. For example, the bracket 20 of the concave mirror 1 described above is also applicable as a bracket of a mirror reflector (such as a plane mirror and a convex mirror) other than the concave mirror body 10. Accordingly, various types of mirror units achieving the above effects can be formed.

### LIST OF REFERENCE SIGNS

1 concave mirror,
10 concave mirror body,
11 reflective surface,
12 underside reflective surface,
13 outer-peripheral end portion,
14 reflective coating,
20 bracket,
21 bracket body,
22 bonded surface portion,
23 outside surface,
24 through hole,
25 enlarged portion,
26 boss portion,
30 adhesive,
31 primer,
100 irradiator

1. A concave mirror comprising:
a concave mirror body made of glass;
a plurality of brackets formed of material with light-impermeable properties; and
an adhesive having ultraviolet-curing properties to bond the brackets to an underside reflective surface of the concave mirror body, wherein
each of the brackets includes
a bonded surface portion to be bonded to an underside reflective surface through the adhesive, the underside reflective surface being a surface of the concave mirror body opposite to a reflective surface thereof,
a plurality of through holes, each of the through holes having one end facing the bonded surface portion and another end facing an outside surface, the outside surface being a surface opposite to the bonded surface portion, each of the through holes passing through between the bonded surface portion and the outside surface,
the concave mirror body is formed with a reflective coating that reflects light irradiated from the underside reflective surface side to the underside reflective surface side, and
the adhesive is applied between the bonded surface portion and the underside reflective surface.

2. The concave mirror according to claim 1, wherein the bracket is bonded to the underside reflective surface on an inner side relative to an outer-peripheral end portion of the concave mirror body.

3. The concave mirror according to claim 1, wherein the bracket includes an enlarged portion around an outer circumference of the through hole at the one end, the enlarged portion being enlarged more than the through hole.

4. The concave mirror according to claim 1, wherein the through holes are arrayed in a lattice pattern.

5. The concave mirror according to claim 1, wherein the bonded surface portion has a shape corresponding to a planar shape of the underside reflective surface.

6. The concave mirror according to claim 1, comprising a primer provided between the adhesive and the bonded surface portion.

7. The concave mirror according to claim 1, wherein ultraviolet light irradiated from at least either an underside reflective surface side or another end side of the through hole is reflected off an underside of the reflective coating formed on the concave mirror body, and then reaches between the bonded surface portion and the underside reflective surface, and thereby the adhesive is cured.
